(19) United States
(12) Patent Application Publication
(10) Pub. No.: US 2020/0379106 A1
(43) Pub. Date: Dec. 3, 2020

(54) DEVICE FOR LOCATION BY ULTRASOUND

(71) Applicant: Centre National de la Recherche Scientifique, PARIS (FR)

(72) Inventor: Gabriel VASILE, GRENOBLE (FR)

(73) Assignee: Centre National de la Recherche Scientifique, PARIS (FR)

(21) Appl. No.: 16/497,030

(22) PCT Filed: Mar. 23, 2018
(86) PCT No.: PCT/EP2018/057496

§ 371 Date: Sep. 24, 2019

(30) Foreign Application Priority Data
Mar. 24, 2017 (FR) 17 52501

(51) Int. Cl. G01S 15/42; G01S 15/00

(52) U.S. Cl. CPC G01S 15/42; G01S 15/003

(57) ABSTRACT

The invention relates to a device for locating a target, comprising: a generator of ultrasonic waves that can be reflected by the target; pairs of first and second sensors repeated in a first direction, the first and second sensors of each pair being arranged in a second direction different from the first direction; and a processing unit suitable for: a) for each pair of sensors, measuring the phase shift between the ultrasonic waves received by the first sensor and by the second sensor; and b) establishing that the target is found on a surface corresponding to the differences between measured phase shifts.

### CROSS REFERENCE TO RELATED APPLICATIONS

This is a U.S. National Phase Application under 35 U.S.C. § 371 of International Patent Application No. PCT/EP2018/057496, filed Mar. 23, 2018, which claims priority of French Patent Application No. 17 52501, filed Mar. 24, 2017. The entire contents of which are hereby incorporated by reference.

### FIELD OF THE INVENTION

The present invention relates to an acoustic device, in particular a device for detecting presence and/or location by ultrasound.

### BACKGROUND

Devices for detecting presence and/or location by ultrasound are used, for example in certain underwater monitoring applications such as the monitoring of ports or the detection of schools of fish. Such devices are also used in applications for monitoring drifting elements in a river or stream, for example close to water capture points used for hydroelectric production or to cool power plants.

FIG. 1 schematically illustrates a device 100 for location by ultrasound. The device 100 comprises ultrasonic sensors 102 repeated in a row with a pitch A0. Each sensor 102 comprises an element 104 that is sensitive to the ultrasounds. The sensors are connected to a processing unit 106. At least one 108 of the sensors 102 is also a generator making it possible to produce ultrasounds.

The device is provided to locate submerged elements, here called targets, for example a potential target T, located in an observed region 110 that surrounds a viewing axis 112. The viewing axis 112 is orthogonal to the row of sensors 102. Each sensor 102 is provided to receive the ultrasounds coming from the observed region 110.

The length of the row of sensors is on the order of several cm to several tens of cm, for example on the order of 10 to 20 cm. The observed region can extend from sensors over dimensions greater than a meter, or even much greater than a meter, for example more than 10 m. Thus, the row of sensors is most often quasi-periodic on the scale of the observed region, and in particular relative to the sensors-target distance.

During operation, ultrasounds with wavelength A are emitted by the generator 108 toward the observed region 110. The wavelength A is typically on the order of 0.15 to 0.5 cm, corresponding in the water to frequencies of between 300 kHz and 1 MHz. The ultrasounds are reflected by the potential target T toward the row of sensors 102. The sensors 102 receive the reflected ultrasounds. The processing unit determines the relative phase of the ultrasounds received by each sensor 102.

The processing unit determines, for a row of quasi-periodic sensors, from differences between the phases measured by the various sensors, an angle a between the row of sensors and the sensors-target direction. In other words, the processing unit determines that the target is located on a cone 114 (shown in section) whose axis is the row of sensors and the half cone angle of which is the angle α.

In order not to obtain, for the angle α, several values corresponding to ultrasound phases differing from multiples of 2π, the pitch A0 of the sensors 102 must be less than half the wavelength λ.

The sensors must therefore have lateral dimensions smaller than half the wavelength, i.e., diameters of less than 2.5 mm for the largest wavelengths mentioned above, or of less than 0.7 mm for the shortest wavelengths. One problem is that the ultrasonic sensors that are commonly available and easy to implement have diameters larger than 2.5 cm, the manufacturing of smaller sensors presents various difficulties, and such small sensors are not very sensitive and have a poor signal-to-noise ratio.

Devices exist of the type of the device 100 comprising several rows of sensors, juxtaposed such that the sensors are in a matrix. The device determines the sensors-target direction, from the angle a obtained from sensors in rows and an angle obtained in the same way from sensors in a column. The pitch of the sensors along the rows and along the columns must be less than half of the wavelength. Such devices therefore have problems similar to those described above.

The known devices have presence detection reliability location precision issues, when:
the water is turbulent;
the ultrasounds emitted by the device are reflected by walls, such as the bed of a river;
the elements that one wishes to detect are moving quickly;
the targets reflect the ultrasounds little, for example small debris, for example smaller than a cm, piles of such debris, or soft targets such as jellyfish or plastic bags; or
the turbidity level of the water is high.

### SUMMARY

One embodiment provides a device for location by ultrasound, making it possible to resolve all or some of the aforesaid drawbacks.

One embodiment provides a target location device that is particularly simple to manufacture.

One embodiment provides a target location device, implementing large sensors, for example with a diameter larger than 2.5 cm, that are readily available and easy to implement.

One embodiment provides a device making it possible to locate the presence of a target reliably in the presence of a wall.

One embodiment provides a target location device weakly reflecting ultrasounds.

One embodiment provides a device for locating targets able to be in motion in an aquatic environment that may be turbulent and/or turbid.

Thus, one embodiment provides a device for locating a target, comprising: a generator of ultrasonic waves that can be reflected by the target; pairs of first and second sensors repeated in a first direction, the first and second sensors of each pair being arranged in a second direction different from the first direction; and a processing unit suitable for: a) for each pair of sensors, measuring the phase shift between the ultrasonic waves received by the first sensor and by the second sensor; and b) establishing that the target is found on a surface corresponding to the differences between measured phase shifts.

According to one embodiment, step b) comprises: for each point of a mesh of an observed region, calculating a theoretical phase shift for each pair of sensors; comparing the differences between theoretical phase shifts to the differences between measured phase shifts; and establishing that the target is located among the points for which the comparison is the best.

According to one embodiment, the pairs of sensors are repeated at a pitch greater than 4 times the wavelength of the ultrasounds, the first and second sensors of each pair are arranged at a center to center distance greater than 4 times the wavelength of the ultrasounds.

According to one embodiment, step a) comprises a measurement of the amplitude of the ultrasounds received by each pair of sensors, and step b) comprises: b1) for each point of the mesh, calculating, for each pair of sensors, a complex value whose modulus is representative of the measured amplitude and the argument is representative of the differences between measured phase shifts and theoretical phase shifts; b2) calculating, for each point of the mesh, a sum S of the complex values of the various pairs of sensors; and b3) selecting the points of the mesh for which the sum S has the maximum modulus.

According to one embodiment, the ultrasounds are emitted by pulses; in step a), for each pair of sensors, the measured phase shift and amplitude are measured as a function of time; and step b) comprises determining the part of said surface for which the times of flight of the pulses toward the various pairs correspond to the reception times of the pulses.

According to one embodiment, step b1) comprises, for each point of the mesh: b11) calculating, for each pair of sensors, a theoretical time of flight of the ultrasounds to the pair of sensors; and b12) for each pair of sensors, selecting the measured phase shift and amplitude of the ultrasounds received at the time corresponding to the theoretical time of flight.

According to one embodiment, step b12) comprises: calculating correlation values between the ultrasounds received by the various pairs of sensors during time intervals centered on the theoretical times of flight; and giving said complex values moduli that are representative of the correlation values.

According to one embodiment, each pulse is an ultrasound train with wavelengths decreasing as a function of time or increasing as a function of time, and step a) comprises, for each pair of sensors: a1) receiving and sampling first and second ultrasonic signals by the first and second sensors; a2) obtaining, by Hilbert transform of each of the first and second ultrasonic signals, first and second complex signals whereof each sample corresponds to a reception time; a3) filtering, by matched filtering, each of the first and second complex signals; a4) associating, with each sample of the first filtered complex signal, the sample of the second filtered complex signal having the best correlation, which results, for each reception time, in a pair of first and second samples of the first and second filtered complex signals; and a5) for each reception time, determining the measured phase shift by subtracting the arguments of the samples of the corresponding pair of samples from each other, and the amplitude measured from the moduli of the samples of the corresponding pair of samples.

According to one embodiment, the processing unit is suitable, after step a4), for one of the pairs of sensors, for: defining a reference line parallel to the axis passing through the first and second sensors; for each reception time, obtaining a phase shift value, representative of the difference between, on the one hand, the measured phase shift and, on the other hand, the theoretical phase shift for the point of the reference line corresponding to the reception time; and determining the distance between the axis of the centers and the target from the phase shift value.

According to one embodiment, step a5) comprises, for each pair of sensors and each reception time: a6) selecting the pairs of samples located in a time interval around the considered reception time; a7) obtaining the phase shift by determining an average difference between the arguments of the first and second samples of the pairs selected in step a6); and a8) measuring the amplitude of the ultrasounds by determining an average modulus of the samples of the pairs selected in step a6).

According to one embodiment, the sensors are suitable for not significantly detecting the ultrasounds coming from directions forming an angle greater than 80° with the second direction.

### BRIEF DESCRIPTION OF THE DRAWINGS

These features and advantages, as well as others, will be described in detail in the following description of specific embodiments done non-limitingly in connection with the attached figures, in which:

FIG. 1, described above, schematically illustrates a device for locating a target by ultrasound as known in the prior art;

FIGS. 2A and 2B are side and front views schematically illustrating an embodiment of a device for detecting presence and locating a target;

FIG. 3 illustrates an exemplary method implemented by the device of FIGS. 2A and 2B;

FIGS. 4A and 4B schematically illustrate an example of a mesh of a region observed by the device 200 of FIGS. 2A and 2B;

FIG. 5A is a timing diagram illustrating ultrasonic signals schematically;

FIG. 5B schematically illustrates an embodiment of a device for detecting the presence of and locating a target, implementing the signals of FIG. 5A;

FIGS. 6A to 6D are timing diagrams schematically illustrating examples of steps carried out by a device for detecting the presence of and locating a target;

FIG. 7 is a side view of a pair of sensors, schematically illustrating an example of another step implemented by a device for detecting the presence of and locating a target;

FIG. 8 is a timing diagram schematically illustrating an example of another step implemented by a device for detecting the presence of and locating a target;

FIG. 9 is a timing diagram schematically illustrating examples of another step implemented by a device for detecting the presence of and locating a target; and

FIG. 10 illustrates another embodiment of a device for detecting the presence of and locating a target by ultrasounds.

### DETAILED DESCRIPTION

Same elements have been designated by same references in the various figures and, additionally, various figures are not drawn to scale. In particular, the dimensions of the ultrasound identification devices are exaggerated relative to those of the observed regions in which the targets can be located. For clarity reasons, only the elements useful to understand the described embodiments have been shown and are described.

In the following description, unless otherwise specified, the expressions “substantially” and “on the order of” mean to within 10%, preferably to within 5%, or, regarding an orientation, to within 10 degrees, preferably to within 5 degrees. Unless otherwise specified, the expression “significantly”, regarding a variation of a value or a difference between values, means by more than 5%, preferably by more than 10%.

Unless otherwise specified, the expression “theoretical”, regarding a value at any given point, means that this value can be calculated, according to a theoretical ultrasound propagation model, by assuming that the ultrasounds are reflected by a target at that point. The theoretical model, for example a constant-speed propagation model, is within the reach of one skilled in the art and is not described.

An effort is made to obtain a device for locating a target, making it possible to determine a location surface near which a target is located, the device being able to implement large sensors, for example having a diameter greater than 2.5 cm.

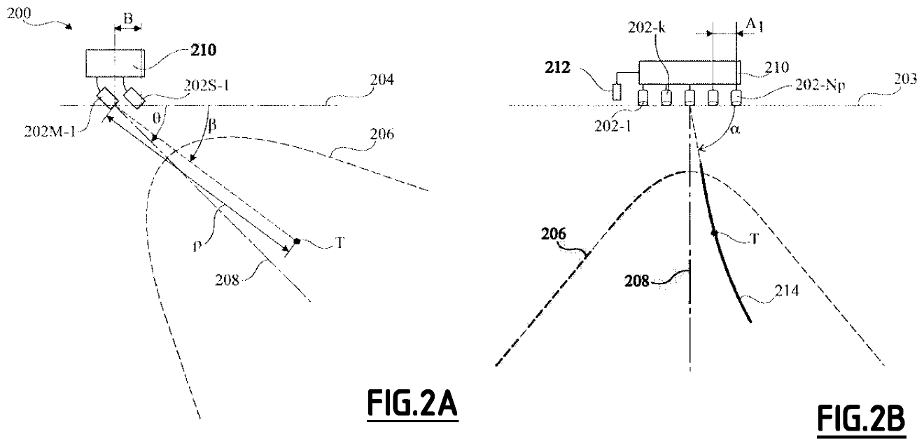

FIGS. 2A and 2B schematically illustrate an embodiment of a device 200 for detecting the presence of and locating a target T by ultrasounds. FIG. 2A is a side view and FIG. 2B is a front view.

The device 200 comprises NP pairs 202-k of sensors 202M-k and 202S-k, k varying from 1 to NP, repeated in a row with a pitch A1 in the direction of an axis 203. In FIG. 2A, the sensors 202M-1 and 202S-1 are located in front of the other sensors, which are therefore not visible. Likewise, in FIG. 2B, only one sensor from each pair 202-k is visible. The sensors of each pair are arranged at a center to center distance B, in the direction of an axis 204. The axis 204 passes through the middle of the line of the pairs of sensors. As an example, the axes 203 and 204 are substantially orthogonal.

Each of the sensors 202M-k, 202S-k is sensitive to the ultrasounds coming from an observed region 206 that surrounds an observation axis 208. The observation axis 208 forms an angle θ with the axis 204.

The sensors are connected to a processing unit 210. As an example, the processing unit comprises a digital circuit, such as a microprocessor suitable for implementing a program recorded in a memory, and analog-digital conversion elements for signals coming from the sensors. The processing unit can be associated with the computer by a remote link, for example by the Internet.

An ultrasound generator 212 (not shown in FIG. 2A), connected to the processing unit and preferably separate from the sensors, makes it possible to send ultrasounds toward the observed region 206. The generator 212 can be arranged in the middle of the sensors or in a remote position. One advantage of an ultrasound generator separate from the sensors is that it can be positioned so as to optimize the reflections of the ultrasounds by the target, as a function of the configuration of the region to be observed, for example as a function of the presence of walls such as the riverbed or a seabed.

As an example, the length of the row of sensors is on the order of several cm to several tens of cm, for example on the order of 10 to 50 cm. The distance B can be several cm, for example on the order of 2.5 to 10 cm. The pitch A₁ can be several cm, for example on the order of 2.5 to 10 cm. The row of pairs of sensors is then in practice quasi-periodic on the scale of the region to be observed.

The processing unit can be provided to detect the presence of a target when, for example, one of the amplitudes Ik of the ultrasounds received by the pairs 202-k is above a threshold.

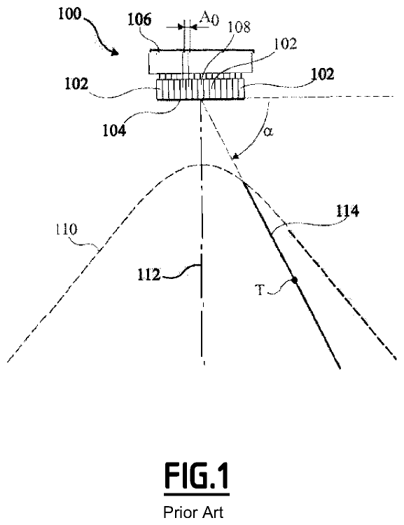

The processing unit 210 is suitable for measuring, for each pair 202-k of sensors, the phase shift Δϕₖ between the ultrasounds received by the sensors 202M-k and 202S-k, and locating the target from the differences Δ(Δϕ) between the phase shifts Δϕₖ measured for the various pairs of sensors. It will be stressed that here that differences are considered between phase shifts of the ultrasounds and not differences between phases of the phase shifts, like in the device 100 of FIG. 1.

The processing unit determines the possible positions of the target for which the differences between the theoretical phase shifts Δϕ′k that would be obtained are best comparable to the differences Δϕk1−Δϕk2 between measured phase shifts (k1 and k2 between 1 and NP). The theoretical phase shifts Δϕ′ₖ for the various pairs can be calculated from a theoretical model taking account of the differences between the paths traveled by the ultrasounds.

The possible positions thus determined are located in a single location surface 214 (shown in section). Furthermore, the location surface thus determined remains unique when the device implements large sensors. One has thus obtained a device for locating a target that is particularly simple to produce.

Section 1 below describes an exemplary location from the comparison between differences in measured phase shifts and differences in theoretical phase shifts, in the simple case of a quasi-periodic row of pairs of sensors, and illustrates that the obtained surface is unique.

Section 2 describes a preferred location method from the comparison between differences in measured phase shifts and differences in theoretical phase shifts, without hypotheses on the dimensions of the row of pairs of sensors. This method, which involves a meshing step (section 2.1), makes it possible to obtain a single possible positioning surface of the target, and can in particular be implemented in the case where, furthermore:

a target is located as a function of the time of flight of the ultrasounds (section 2.2);

weakly reflective targets are located with a high resolution (section 2.3);

a target is detected and located in the presence of a wall and/or the possible positions of a target are defined by easy-to-use coordinates (section 2.4); and/or

the water is turbulent and/or turbid, and/or the target moves (sections 2.5 and 2.6).

### 1 Example of Determination of a Location Surface for a Quasi-Periodic Row of Pairs of Sensors

To locate a target from differences between measured phase shifts in the case of a quasi-periodic row of pairs of sensors, it is possible to determine the angle a between the axis 203 and the sensors-target direction, which verifies the equation:

$$Δ ( Δ φ ) = \frac{2 π}{λ} {A}_{1} ( \frac{B}{ρ} cos β ) cos α \qquad ( 1 )$$

where Δ(Δϕ) is a value representative of the differences between the measured phase shifts Δϕₖ for the adjacent pairs, for example an average value,
the angle β is the angle between the axis 204 and the sensors-target direction,
ρ is the sensors-target distance, and
as mentioned above, A1 is the pitch of the pairs of sensors, B is the distance between sensors of a pair, and λ is the wavelength.

In order for a single value of the angle α to verify equation (1), the value A₁(B cos β)/ρ must be less than half of the wavelength λ. The distance B between the sensors of a same pair being much smaller than the distance ρ between the sensors and the target, this condition is verified. Thus, the pitch A1 of the pairs of sensors can be greater than half of the wavelength λ, preferably more than 4 times the wavelength λ.

The angle α thus obtained corresponds to a single location surface 214 of the target. It will be noted that the angle α depends on the angle β and the distance ρ. The surface 214 thus defined is therefore different from the previously cited cones for the device 100. For example, for differences close to zero between measured phase shifts, the surface 214 is close to the plane of the axes 204 and 208.

The angle θ between the observation axis and the axis 204 is preferably provided such that the sensors are not sensitive to ultrasounds coming from directions corresponding to an angle β close to 90°. This makes it possible to avoid the values of the angle β for which the phase shifts are too small to determine the angle a with precision.

### 2 General Method for Presence Detection and Location of a Target

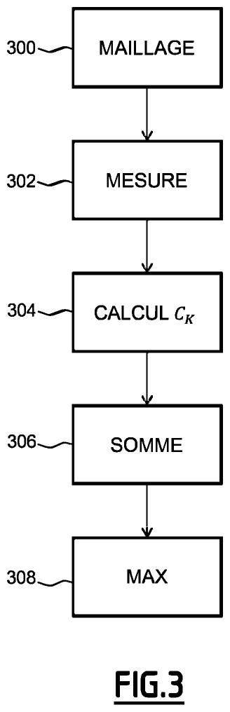

FIG. 3 illustrates an exemplary general method for presence detection of a target and determining the aforementioned angle α, in particular in the case where there is no hypothesis on the dimensions of the row of sensors.

As an example, the points of the observed region are located by angles α and β and a distance ρ as defined in section 1 above, the sensors-target direction and the sensors-target distance being defined relative to a central point of the row of pairs of sensors.

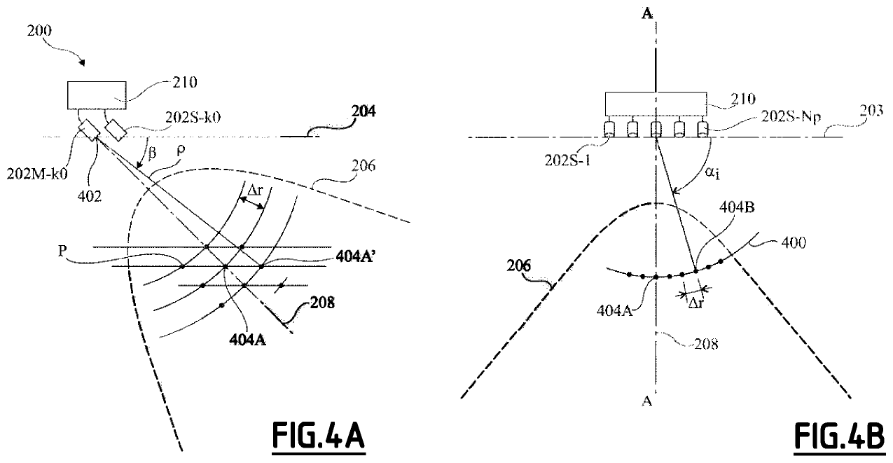

In a mesh step 300 (MESH), pairs of values of the angle β and of the distance ρ are defined. These pairs can correspond to points of a mesh of the plane of the axes 204 and 208 (plane of FIG. 2A). For each of these pairs of values β and ρ, angles αi are defined among which the angle α is sought. One thus obtains a mesh of the observed region. One example of such a mesh step will be described in more detail hereinafter in section 2.1 (FIGS. 4A and 4B). The mesh step can have been provided in advance, for example during the programming of the processing unit, and thus be shared by the various embodiments of the method.

In a step 302 (MEASURE), one measures, as previously described, the phase shifts Δϕk for the various pairs of sensors. One can also measure the amplitudes Ik.

The following steps of the method are carried out for each pair of values β and ρ.

In a step 304 (COMPUTE-Ck), for each pair 202-k of sensors and for each angle αi, a complex value Ck is calculated for example defined by the relationship: t,?

where j represents the imaginary unit. As an example, in the case of a quasi-periodic row of sensors, the theoretical phase shifts Δϕ′k are defined by the relationship:

$$Δ {φ}_{k}^{′} = k \frac{2 π}{λ} {A}_{1} ( \frac{B}{ρ} cos β ) cos {α}_{i} . \qquad ( 3 )$$

As a variant, it is possible, for the theoretical phase shifts Δϕ′ₖ, to choose other values differing from that of relationship (3) by a value shared by all of the pairs of sensors.

In a step 306 (SUM), for each angle αi, the sum of the complex values Ck is calculated for the various pairs of sensors.

In a step 308 (MAX), chosen as angle α is the angle αi for which the sum of the values Ck has the maximum modulus. The presence of the target can then be detected when this maximum modulus is above a threshold. As a variant, in step 308, the angle α is sought by successive iterations.

For each of the pairs of values β et ρ, the obtained angle α is the only angle for which the differences between measured phase shifts are best compared to the differences between theoretical phase shifts. The method of FIG. 3 thus makes it possible to determine a single location surface, in particular without hypothesizing as to the length of the row of pairs of sensors. The following sections 2.1 to 2.6 provide more detailed presentations of various examples and variants of the steps of the general method described here.

### 2.1 Exemplary Mesh Step.

Here it is sought to define a mesh making it possible to implement the method of FIG. 3 simply and quickly, without limiting the resolution with which the target is located.

FIGS. 4A and 4B schematically illustrate an example of the mesh of the region 206 observed by the device 200 of FIGS. 2A and 2B. FIG. 4A is a sectional view in the plane A-A of the axes 204 and 208. FIG. 4B is a front view. As an example, the meeting point 402 of the axes 203 and 204 is located at the center of the sensor 202M-k0, where the index k0 is equal to N_{P}/2.

As mentioned above, a mesh is made of the plane of the axes 204 and 208. To that end, first a set of distances ρ is defined from the points of the mesh to the point 402, for example with a regular pitch Δr. The mesh comprises, for each distance ρ, a point 404A located on the observation axis at the distance ρ from the point 402. For each of the points 404A, the mesh comprises points 404A′ located in the plane of FIG. 4A, at the same distance from the axis 204 as the point 404A, each point 404A′ corresponding to one of the distances ρ.

For each point 404A or 404A′, the mesh of the observed region comprises points 404B, visible in FIG. 4B, for which the distance ρ (from the point 402 to the considered point) and the angle β (between the axis 204 in the direction from the point 402 to the considered point) are the same. Each point 404B of the mesh is associated with one of the aforementioned angles αi (between the axis 203 and the direction from the point 402 to the point 404B). The points 404B can be regularly spaced apart, for example with the pitch Δr.

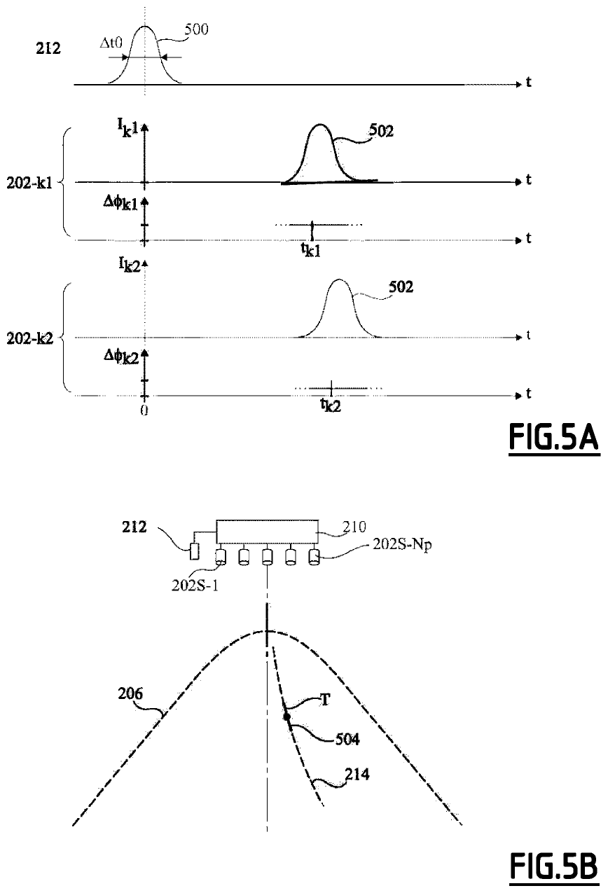

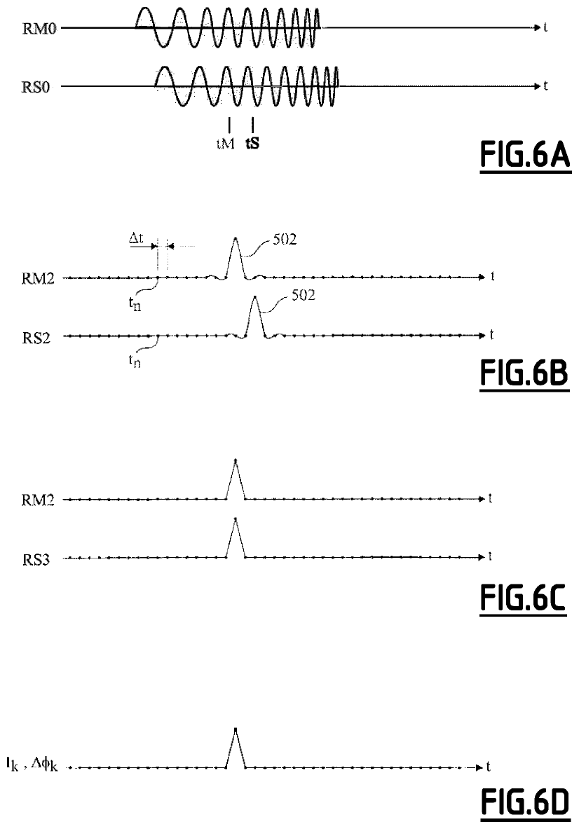

One has thus obtained a regular mesh of the observed region that makes it possible to carry out the method of FIG. 3 simply and quickly. Furthermore, the obtained mesh is particularly suitable for implementing the steps of section 2.3 below (FIGS. 6A to 6D) for locating the target with a high resolution, for example close to half of the wavelength. One will then choose, for the pitch Δr, a value on the order of half of the wavelength.

2.2 Location of a Target from the Time of Flight of the Ultrasounds.

Here, one seeks to limit the location surface 214 in which a target can be found. To that end, one determines a portion of the surface 214, for which the theoretical time of flight of the ultrasounds corresponds to the measured time of flight.

The generator 212 is provided to emit the ultrasounds by pulses. As an example, the processing unit 210 implements a method similar to that of FIG. 3, in which one begins by measuring amplitude Ik(t) and phase shift Δϕk(t) signals as a function of time, from which one next determines the measured amplitude Ik and the measured phase shift Δϕk. In particular, the method comprises examples of steps 302 and 304 of FIG. 3, described here in connection with FIGS. 5A and 5B.

FIG. 5A is a timing diagram schematically illustrating ultrasonic signals emitted, then measured in step 302 of the method. FIG. 5B shows a schematic front view of the device.

An ultrasonic pulse 500 with width Δt0 is first emitted by the generator 212. The central time of the emission of the pulse serves as time reference t=0, and the time of flight thus corresponds to the central reception time. FIG. 5A shows the envelope of the emitted ultrasonic waves, the detail of these waves not being shown.

In step 302, in each pair 202-k, the sensors 202M-k and 202S-k each receive an ultrasonic signal as a function of time. The processing unit measures, for each pair of sensors, as a function of the reception time:
a signal with amplitude I(t) of the ultrasounds received by the pair of sensors, for example the amplitude of the ultrasounds received by the sensor 202M-k; and
a phase shift signal Δϕk(t) between the ultrasound waves received by the sensor 202M and those received by the sensor 202S-k.

The amplitude and phase shift signals of two (202-k1 and 202-k2) of the pairs of sensors are shown. The amplitude signal of each pair of sensors optionally has a pulse 502 corresponding to a target T. The phase shift signal can only be defined for the useful values 504 for later, which correspond to the times where the amplitude is sufficient to be able to measure the phase shift.

Preferably, the amplitude and phase shift signals are sampled signals with values Ik(tn) and Δϕk(tn), the reception times tn (not shown in FIG. 5) for example being at regular intervals.

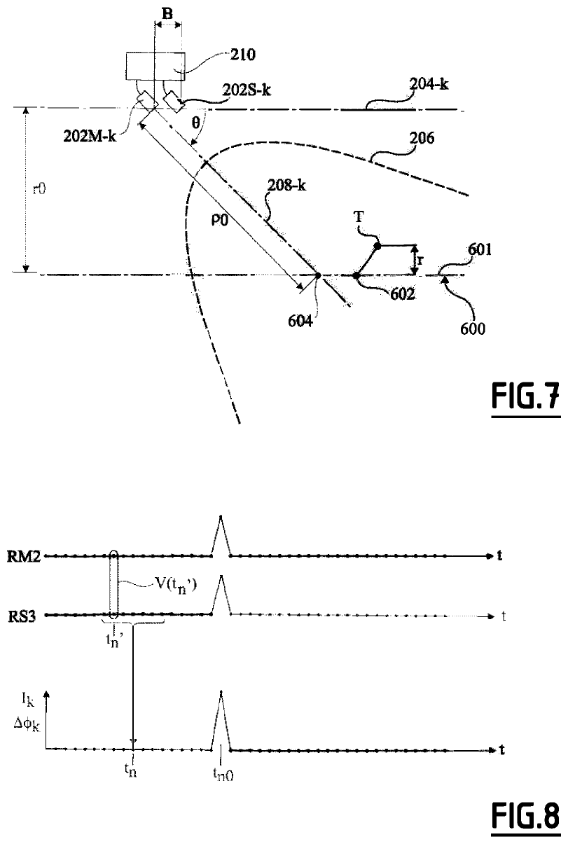

Examples of steps for measuring amplitude and phase shift signals for each pair of sensors will be described in more detail hereinafter, in section 2.3 (FIGS. 6A to 6D) in order to obtain a high resolution and signal-to-noise ratio, in section 2.4 (FIG. 7) to distinguish the target from a wall, and in section 2.5 (FIG. 8) in the case of turbulent and/or turbid water.

In step 304, for each point 404 of the mesh, and for each pair of sensors, the theoretical time of flight tk of the ultrasounds is calculated to reach the pair of sensors, for example the sensor 202M-k.

It will be noted that, in the case where the generator 212 is located among the sensors, the distances ρ from the points of the mesh to the sensors are associated with theoretical times of flight tk, which allows easy calculations of the times of flight. In the case where the generator 212 is not located among the sensors, it will preferably be possible to define a mesh like that of the previous section 2.1, in which the various distances p from the points of the mesh are replaced by various generator-target-sensors distances traveled by the ultrasounds. This allows the calculations of the times of flight to be done easily.

In order to next obtain the measured amplitude and phase shift, it is possible to give the value Ik(tk) to the measured amplitude Ik and the value Δϕk(tk) to the measured phase shift Δϕk. In the case of sampled signals, it is possible to use, for the measured amplitude Ik and phase shift Δϕk, the respective values Ik(tn) and Δϕk(tn), for the reception time tn closest to the theoretical time closest to the theoretical time of flight tk.

The complex value Ck can next be calculated in the manner described in connection with FIG. 3 (relationship (2)) by using the measured amplitude Ik and phase shift Δϕk values thus determined. The complex value Ck can also be determined, from amplitude Ik(t) and phase shift Δϕk(t) signals, in a manner described below in section 2.6 (FIG. 9).

Steps 306 and 308 of FIG. 3 are next carried out.

The method of this section 2.2 makes it possible to establish that the target is located in a limited portion 504 of the surface 214 previously determined.

### 2.3 High-Resolution Location.

A high-resolution location is sought of a target that may be weakly reflective. To that end, the method of the previous section 2.2 is implemented, in which a variant is used of the step for measuring signals with amplitude Ik(t) and phase shift Δϕk(t) of the various pairs of sensors, making it possible to obtain these signals with a high resolution and signal-to-noise ratio.

FIGS. 6A to 6D are timing diagrams schematically illustrating examples of steps carried out by a device for detecting and locating a target of the type of FIGS. 2A and 2B. These steps make it possible to determine measured sampled signals with amplitude Ik(t) and phase shift Δϕk(t) for one 202-k of the pairs of sensors.

In an initial step that is not shown, an ultrasonic pulse is generated. The pulse is an ultrasound train of increasing frequency as a function of time. As an example, the frequency scans the range of frequencies of between 300 kHz and 1.2 MHz. As an example, the total duration of the pulse is between 0.5 ms and 2 ms, for example 1 ms.

In the step of FIG. 6A, each sensor of the pair 202-k receives an ultrasonic signal. The sensor 202M-k receives a signal RM0 and the sensor 202S-k receives a signal RS0, as a function of time t. An ultrasound train reflected by a potential target reaches the two sensors at times tM and tS (at the center of the received pulses). The times tM and tS have a shift as a function of the position of the target. In practice, the duration of the pulse is much greater than the shift between the times tM and tS.

The signals RM0 and RS0 are next sampled. Each sample RM0(tn) or RS0(tn) corresponds to a reception time tn of the ultrasounds by the corresponding sensor. As an example, the sampling frequency 1/Δt of the signal RM0 is substantially equal to 4 times the central frequency of the pulse. As an example, the sampling frequencies are identical for the sampled signals RM0 and RS0. As a variant, the sampling frequency of the signal RS0 is greater than that of the signal RM0, for example 8 times greater.

For each of the signals RM0 and RS0, one next uses a Hilbert transform to determine a sampled complex signal, respectively RM1 and RS1. For each sample RM1(tn) or RS1(tn), the modulus and the argument respectively correspond to the amplitude and the relative phase of the received ultrasounds.

In the step of FIG. 6B, sampled complex signals RM2 and RS2 are obtained, by matched filtering of each of the signals RM1 and RS1.

As an example, the suitable filtering of RM1 or RS1 consists, for each time of flight tn, of implementing the relationship:

$$R 2 ( {t}_{n} ) = {{\sum }^{N 1}}_{n = - N 1} R 1 ( {t}_{n + {n}^{′}} ) f 1 ( {t}_{{n}^{′}} ) Δ t \qquad ( 4 )$$

where R1 is the signal RM1 or RS1,
R2 is the signal RM2 or RS2, and
f1 is a sampled complex signal representative of the ultrasounds emitted by the generator between times t-N1 and tN1, sampled at the frequency 1/Δt and obtained by Hilbert transform.

The signal f1 can correspond directly to the emitted signal, or to a signal received by one of the sensors after propagation in the water, for example measured during a pre-setting phase of the device. As a variant, the signal f1 can be a matched filter reference signal obtained in the manner described in relation to section II and FIG. 2 of the document “Reference Selection for an Active Ultrasound Wild Salmon Monitoring System”, by Vasile G. et al., MTS/IEEE North American OCEANS conference, Washington D.C., USA, published in 2015.

The matched filtering results in concentrating, around a same time, tM for the signal RM2 and tS for the signal RS2, the ultrasounds reflected by a target. One then obtains pulses 502 in each of the signals. As an example, the width of the pulses is on the order of the duration Δt, for example such that in each signal, the pulse 502 only significantly relates to one or two samples. For each sample RM2(tM) or RS2(tS), the modulus and the argument are respectively representative of the amplitude and the relative phase of the ultrasounds reflected by the target.

In the step of FIG. 6C, associated with each sample RM2(tn) of the signal RM2 is the sample RS2(tn′) for which the signal RS2 has the best correlation with the signal RM2. One obtains a sampled complex signal defined by the relationship RS3(tn)=RS2(tn′). One has thus formed a pair of samples RM2(tn), RS3(tn) for each reception time tn. As an example, the correlation is over a period with duration Δt2, centered on the sample RM2(tn) for the signal RM2 and on the sample RS2(tn′) for the signal RS2.

As a variant, the signal RS2 can be oversampled, for example by a factor 8, before the step of FIG. 6C, or the signal RS2 can have kept the sampling frequency of the signal RS0 in the case where this frequency is higher than that of the signal RM0.

As an example, the signal RS3 can be determined, in the present case of ultrasound pulses, in a manner similar to that described for radar pulses in section 1.3, page 17 of the document “Imagerie Radar à Synthèse d'Ouverture interfèromètrique et polarimètrique”, Doctoral Thesis by Vasile G., Universitè de Savoie, France, 2007.

In the step of FIG. 6D, one determines the signals with measured amplitude Ik(t) and phase shift Δϕk(t). As an example, each value Ik(tn) is representative of the moduli of the samples RM2(tn) and RS3(tn), for example the average of the moduli. As an example, each value Δϕk(tn) is the difference between arguments of the samples RS3(tn) and RM2(tn). Another example of determination of the signals Ik(t) and Δϕk(t) from signals RM2 and RS3 will be described below in section 2.5 (FIG. 8).

One advantage of steps 6A to 6D is that they allow the implementation of matched filtering. Due to the matched filtering, the amplitude and phase shift signals thus measured have an improved signal-to-noise ratio, allowing the location of a signal reflecting the ultrasounds little. Furthermore, the matched filtering allows a high resolution.

The implementation of the steps of this section 2.3 (FIGS. 6A to 6D) in the method of section 2.2 (FIGS. 5A and 5B) therefore allows a high-resolution location of targets weakly reflecting ultrasounds.

Furthermore, one advantage of using large sensors is that they allow a particularly high signal-to-noise ratio and resolution, due to the fact that such sensors have particularly wide frequency ranges. Indeed, the matched filtering allows an even higher signal-to-noise ratio and resolution when the frequency range scanned by the ultrasound train is wide. One can thus obtain a resolution on the order of half of the central wavelength of the ultrasounds.

Thus, a location device of the type of that of FIGS. 2A and 2B, the sensors of which are large, and implementing the method of section 2.2 (FIGS. 5A and 5B) comprising the steps of this section 2.3 (FIGS. 6A to 6D), makes it possible to identify targets weakly reflecting ultrasounds with a particularly high resolution.

### 2.4 Detection and Location of a Target in the Presence of a Wall

Here, one seeks to detect the presence of a target reliably, and to further limit the surface on which the target can be located, even in the presence of a wall delimiting the observed region. One further seeks to express the possible positions of the target in a simple manner.

To that end, an optional step is implemented that for example uses the signals RS2 and RS3 determined in the previous section 2.3.

FIG. 7 is a side view of a pair 202-k of sensors, illustrating an example of an optional step implemented by a device for locating a target. As an example, the device has been positioned so that the plane of the sensors (axes 203 and 204) is parallel to a wall 600 such as the bottom of a river. The wall 600 corresponds to a line 601 in the plane of the figure (that is to say, in the plane of an axis 204-k passing through both sensors and an axis 208-k parallel to the observation axis passing through the sensor 208M-k).

For each sample RS3(tn) of the signal RS3 determined in the previous step 2.3, FIG. 6C, one determines, on the line 601, the point 602 for which the time of flight corresponds to the reception time tn. One then calculates a value Δψk(tn) representative of the theoretical phase shift Δϕ′k(tn) for the point 602.

As an example, for a quasi-periodic pair of sensors and a quasi-periodic pair-generator distance on the scale of the sensors-target distance, and to identify a target close to the meeting point 604 between the observation axis 208-k and the wall 600 (that is to say, a target-point distance 604 much smaller than the sensors-target distance, for example more than 20 times smaller), it is possible to calculate the values Δψk(tn) from the following relationship:

$${Δ}_{{Ψ}_{k}} ( {t}_{n} ) = 2 π ( \frac{B sin θ}{{ρ}_{0}} tan θ ) \frac{f}{2} {t}_{n} \qquad ( 5 )$$

where ρ0 is the distance between the sensor 202M-k and the point 604,
f is the central frequency of the ultrasonic pulses, and
as previously described, θ is the angle between the axes 208 and 204 and B is the distance between the sensors 202M-k and 202S-k.

It will be noted that the values Δψk(tn) calculated according to relationship (5) correspond to the theoretical phase shift for the point 602 to which a constant value ψ0 has been added, equal to Δψₖ(t604)-B cos θ, where t604 is the theoretical time of flight for the point 604. As a variant, in order to obtain the value Δψk(tn), it is possible to add any constant value, i.e., not depending on tn, to the theoretical phase shift Δϕ′k(tn) for the point 602.

One next obtains a sampled complex signal RS3′ from the signal RS3 by adding the value Δψk(tn) to the argument for each sample RS3(tn). After this, one determines a phase shift signal Δϕ1k(t) from the signals RS3′ and RM2, for example in a manner similar to that making it possible to determine the phase shift signal Δϕk(t) from signals RM2 and RS3, described in the previous section 2.3, FIG. 6D. As a variant, the phase shift signal Δϕ1k(t) can also be determined in a manner similar to that described below in section 2.5.

The presence of the target T in front of the wall can then be detected when one, Δϕ1k(tn0), of the values Δϕ1k(tn) of the signal Δϕ1k(t) deviates significantly from the others of the values of this signal, for example by more than 10%. Indeed, the value Δϕ1k(tn0) obtained for one pair of sensors only depends on the distance r of the target from the wall 600, and the value Δϕ1k(tn0) corresponds to the target when the other values Δϕ1k(tn) correspond to the wall. The presence of a target is detected reliably, even in the presence of a wall reflecting the ultrasounds.

Furthermore, it is possible to determine the distance r from the wall of a target close to the point 604. To that end, it is possible to use the value Δϕ1k(tn0). Indeed, this value only significantly depends on the distance r.

Furthermore, although a wall is present here as an example, as a variant, the target can be identified by its distance from other surfaces, such as, in the case of a quasi-periodic generator-sensor distance, a cylinder with radius r0 and, as axis, the axis 204-k. The line 601 is then located at the distance r0 from the axis 204-k. Indeed, the value Δϕ1k(tn0) only significantly depends on the distance between the target and the axis 204-k. In particular, the constant value ψ0 mentioned above makes it possible for the value Δϕ1k(tn0) to be nil when the target is on the cylinder, and the distance between the target and the cylinder is then particularly easy to obtain.

Furthermore, after having determined the phase shift signal Δϕ1k(t) for the various pairs of sensors, it is possible to locate the target by next implementing steps similar to the steps 304, 306 and 308 of FIG. 3, preferably the examples of these steps described in section 2.2, by using the values Δϕ1k(tn) in place of the phase shifts Δϕk(tn), and by using theoretical values Δϕ1′k(tn) in place of the theoretical phase shifts Δϕk′(tn). The theoretical values Δϕ1′k(tn) are obtained from theoretical phase shifts Δϕk′(tn) in the same manner as to obtain the values Δϕ1k(tn) from the measured phase shifts Δϕk(tn). One obtains the same surface 214 as before, in which the possible positions of the target are expressed as a function of the distance to the axis 204, in place of the angle β that is more difficult to use. The mesh described in section 2.1 is particularly suitable for thus expressing the possible positions of the target.

The optional step of this section 2.4 thus makes it possible to detect the presence of a target reliably, and/or to limit the surface on which the target can be located, even in the presence of an observed region delimited by a wall. This step further makes it possible to express the possible positions of the target in a simple manner.

### 2.5 Measurement of the Amplitude and Phase Shift of the Ultrasounds in a Turbulent or Turbid Environment

Here, one seeks to locate a target reliably and precisely when the water is turbulent and/or turbid, and/or when the target moves. To that end, in a method implementing, for each pair of sensors, the steps of section 2.3 (FIGS. 6A to 6D), and optionally of section 2.4 (FIG. 7), one uses, in order to obtain the amplitude Ik(t) and phase shift Δϕk(t) signals, a variant of the step of FIG. 6D.

FIG. 8 is a timing diagram schematically illustrating a step for obtaining, for a pair of sensors 202-k, amplitude Ik(t) and phase shift Δϕk(t) signals from the signal RM2 and for example from the signal RS3 of the step of section 2.3, FIG. 6C. As a variant, it is possible to use, in place of the signal RS3, the signal RS3′ of the step of section 2.4 (FIG. 7).

For each reception time tn′, a vector V(tn′) of the samples RM2(tn′) and RS3(tn′) is formed, that is to say:

$$V ( {t}_{{n}^{′}} ) = ( \begin{matrix}RM 2 ( {t}_{{n}^{′}} ) \\ RS 3 ( {t}_{{n}^{′}} )\end{matrix} ) \qquad ( 6 )$$

For each reception time tn, N2 consecutive reception times tn′ are selected closest to the time tn, located between times tn−N2/2 and tn+N2/2. As an example, the imager N2 is shared by all of the reception times. One next determines a covariance matrix Cov(tₙ) (with size 2×2) of the selected vectors V(t_{n′}).

As an example, the matrix Cov(tn) is sought, for signals corresponding to ultrasounds, in the manner described for radar waves in section IIC, paragraph 2 and equation [13] of the document “Stable scatterers detection and tracking in heterogeneous clutter by repeat pass SAR interferometry” by G. Vasile et al., Asilomar Conference on Signals, Systems, and Computers, Pacific Grove, Calif., USA, p 1343-1347, published in 2010. Thus, the matrix Cov(tn) can be found as solution to the equation:

$$Cov ( {t}_{n} ) = \frac{1}{N 2} {\sum }_{{n}^{′} = n - N 2 \text{/} 2}^{n + N 2 \text{/} 2} \frac{V ( {t}_{{n}^{′}} ) \cdot {V}^{H} ( {t}_{{n}^{′}} )}{{V}^{H} ( {t}_{{n}^{′}} ) \cdot {Cov}^{- 1} ( {t}_{n} ) \cdot V ( {t}_{{n}^{′}} )} \qquad ( 7 )$$

where VH(tn) is the conjugated complex transposed vector of the vector VH(tn), and Cov-1(tn) is the inverse matrix of the matrix Cov(tn). To find this solution, successive iterations can be carried out. The covariance matrix can also be determined through other known methods.

Next, for each reception time, the measured amplitude value Ik(tn) is further determined by the relationship:

Iₖ(tₙ)=V^{H}(t_{n′})·Cov⁻¹(tₙ)·V(t_{n′}) (8)

and one determines, as measured phase shift Δϕk(tn), the argument of the element Cov12(tn) (1st row, 2nd column) of the matrix Cov(tn).

The measured amplitude Ik(t) and phase shift Δϕk(t) signals, thus determined for each pair of sensors of a device of the type of that of FIGS. 2A and 2B, make it possible, when one uses these signals for example in a method of the type of that of section 2.2, to locate a target particularly reliably in water that may be turbulent and/or turbid, even for a moving target.

Each value Ik(tn) thus obtained is representative of the moduli of the selected samples RM2(tn′) and RS3(tn′) about the time tn. As a variant, it is possible to choose, for the value Ik(tn), any value representative of the moduli of the selected samples, for example an average value of these moduli. Furthermore, each value Δϕk(tn) obtained here is representative of the differences between the arguments of each pair RM2(tn′), RS3(tn′) of selected samples. As a variant, it is possible to choose, for the value Δϕk(tn), any value representative of these differences, for example the average value of the differences between the arguments of the selected pairs.

As a variant, the processing unit is further capable of implementing a phase correlation signal E(t), each value E(tn) of which is defined by the relationship:

$$E ( {t}_{n} ) = \vert \frac{{Cov}_{12} ( {t}_{n} )}{\sqrt{{Cov}_{11} ( {t}_{n} ) \cdot {Cov}_{22} ( {t}_{n} )}} \vert \qquad ( 9 )$$

where ∥ represents the modulus. The device can then detect the presence of the target T when one E(tn0) of the values of phase correlation signal is above a threshold, for example 0.3. The presence of the target can also be detected when one of the values of the correlation signal deviates significantly from the other values of this signal, for example, deviates by more than 0.1. The use of a statistical correlation signal between signals received by the two sensors, such as the signal E(t), makes it possible to detect the presence of a target particularly reliably. In particular, it is possible to detect, particularly reliably, the presence of a target that may have a low reflectivity and/or be in motion in a turbulent and/or turbid environment.

In this section 2.5, the step for determining the amplitude Ik(t) and phase shift Δϕk(t) signals for each pair of sensors thus makes it possible to locate, in a turbulent and/or turbid environment, a target that may be in motion.

2.6 Location in Turbulent and/or Turbid Environment

Here, one seeks to obtain a device of the type of that of FIGS. 2A and 2B, allowing a reliable and precise location when the water is turbulent and/or turbid, and/or when the potential target is in motion. To that end, in a location method from the time of flight of the type of that of section 2.2, a variant of step 304 is used, in which relationship (2) providing the complex value Ck is replaced by a calculation step described hereinafter.

FIG. 9 is a timing diagram illustrating an example of a calculation of the complex value Ck of step 304 for each point of a mesh, from the theoretical phase shifts Δϕ′k and amplitude Ik(t) and phase shift Δϕk(t) signals. The amplitude and phase shift signals have been shown for two pairs 202-k1 and 202-k2 of sensors. Preferably, the signals Ik(t) and Δϕk(t) have been obtained in a step of the type of that of the previous section 2.5 (FIG. 8). The calculation described here is of the type of that described in the document “High-resolution frequency-wavenumber spectrum analysis” by J. Capon, which appeared in 1969 in Proceedings of the IEEE, vol. 57(8), 1408-1418.

As mentioned in connection with FIG. 3, for each pair of sensors 202-k, the time of flight tk of the ultrasounds is calculated up to the pair of sensors. One next selects N3 consecutive reception times tk+n′ closest to the time tk, located between times tk−N3/2 and tk+N3/2, the index n′ varying between −N3/2 and N3/2. N3 is for example greater than k squared.

For each of the N3 values of the index n′, a vector V1(n′) is formed of NP complex values C1k having Ik(tk+n′) for modulus and Δϕk(tk+n′) for argument, that is to say:

$$V 1 ( {n}^{′} ) = ( \begin{matrix}⋮ \\ {I}_{k} ( {t}_{k + {n}^{′}} ) exp ( j \cdot Δ {φ}_{k} ( {t}_{k + {n}^{′}} ) ) \\ ⋮\end{matrix} ) \qquad ( 10 )$$

where j is the imaginary unit.

One next calculates the covariance matrix Cov1 of the N3 vectors V1(n′). The matrix Cov1 can be calculated in a manner similar to that described in connection with FIG. 8.

One further forms a vector Vϕ′ of the NP unitary complex values having, for arguments, the theoretical phase shifts Δϕ′k, that is to say:

$$V {φ}^{′} = ( \begin{matrix}⋮ \\ exp ( j \cdot Δ {φ}_{k}^{′} ) \\ ⋮\end{matrix} ) \qquad ( 11 )$$

One then calculates the transposed vector V2, with dimension NP, defined by the relationship:

$$V 2 = \frac{V {φ}^{{′}^{H}} \cdot Cov {1}^{- 1}}{V {φ}^{{′}^{H}} \cdot Cov {1}^{- 1} \cdot V {φ}^{′}} \qquad ( 12 )$$

where the Vϕ′H is the conjugated complex transposed vector of the vector Vϕ′, and Cov1-1 is the inverse of the matrix Cov1.

For each pair k, the complex value Ck is then calculated from the relationship:

Cₖ=V2ₖ exp(j·Δϕₖ(tₖ)) (13)

where V2k is the kth component of the vector V2.

After the implementation of steps 306 and 308 with the complex values Ck thus obtained, the potential target is located particularly reliably and precisely when the water is turbulent and/or turbid, and/or when the target is in motion.

The complex value Ck obtained here for each pair of sensors has its modulus representative of the intensity of the received ultrasounds and its argument representative of the difference between measured phase shift and theoretical phase shift. As a variant, it is possible to calculate complex values Ck using any other type of suitable statistical correlation between signals received by the various sensors at times close to the theoretical times of flight, for example by combining the values of V2k obtained for several values of N3. Furthermore, it is possible here to use statistical correlations making it possible to measure the speed of the target, for example by implementing the following steps:
choosing a set of speeds u among which that of the target is sought;
for each speed u, calculating the statistical correlations V2 and the complex values Ck in the manner described above by replacing relationship (11) with relationship:

$$V φ = ( \begin{matrix}⋮ \\ exp ( j \cdot Δ {φ}_{k}^{′} ) + \frac{{t}_{k}}{λ} u \\ ⋮\end{matrix} ) \qquad ( 14 )$$

where λ is the central wavelength of the ultrasounds;
in step 306, for each speed u, calculating the sum of the complex values Ck for the various sensors; and
in step 308, for each point where the target is located, choosing as measured speed of the target, the speed u for which the sum is maximal.

Here we have described steps making it possible to locate a target, which may be in motion, in a turbulent and/or turbid environment. A method of the type of that of FIG. 3 can implement the steps of sections 2.2, 2.3, 2.5 (optionally after that of section 2.4) in order to determine the measured amplitude and phase shift signals for each pair of sensors, and the step of section 2.6 to locate the target from amplitude and phase shift signals of the various pairs of sensors. One obtains a particularly reliable detection and/or location in a turbulent and/or turbid environment, and can further measure the speed of a potential target.

### 3 Other Embodiments

Specific embodiments have been described. Different variants and modifications will appear to one skilled in the art. In particular, although devices described above comprise a single row of pairs of sensors, it is possible to provide devices comprising several rows of pairs of sensors.

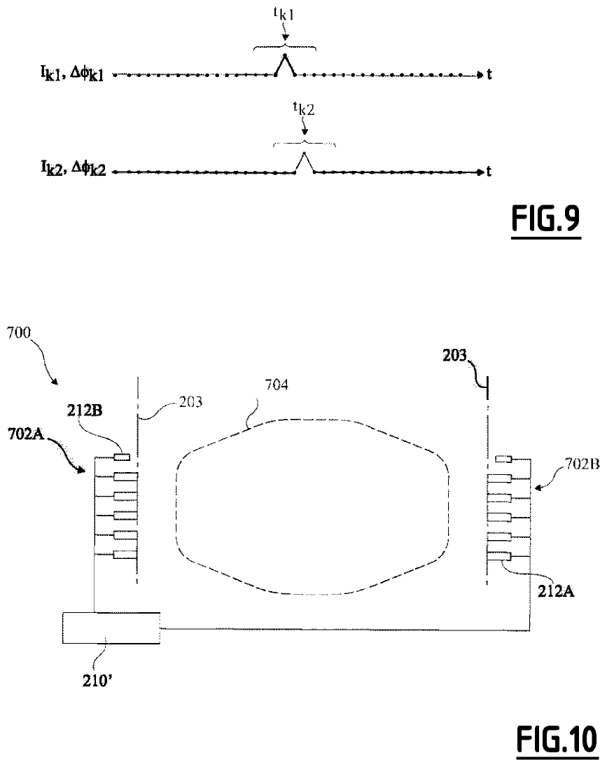

FIG. 10 is a front view of an exemplary device 700 for locating a target comprising two rows 702A and 702B of pairs 202 of sensors.

The rows of pairs of sensors are parallel to one another on either side of an observed region 704. As an example, the sensors of each pair are in a shared direction orthogonal to the axes 203 of the rows (i.e., orthogonal to the plane of FIG. 10). Thus, a single sensor of each pair is visible in FIG. 10.

An ultrasound generator 212A is arranged near the row 702B, for example at a distance for instance of between 5 cm and 20 cm. An ultrasound generator 212B is located near the row 702A.

As an example, the distance between the two rows is greater than 1 m, for example between 1 and 50 m.

During operation, ultrasounds are first emitted by the generator 212A, and these ultrasounds reflected by potential targets are received by the sensors of the row 702A. A processing unit 210′ then implements a method for example of the type of that of FIG. 3, in order to identify these potential targets from differences between phase shifts for the various pairs of sensors of the row 702A.

Ultrasounds are next emitted by the generator 212B, and these ultrasounds reflected by potential targets are received by the pairs of sensors of the row 702B. The processing unit 210′ then again implements a method, for example of the type of that of FIG. 3, using the differences between phase shifts for the various pairs of sensors of the row 702B.

One advantage of using two rows of sensors is that one avoids any masking effects of one target by another or by any obstacles present in the observed region. One thus obtains an improved detection of the targets.

As a variant, after each emission of ultrasounds by the generator 212A or the generator 212B, the processing unit can use the ultrasonic signals received by both rows 702A and 702B, and establish that the target is located among the shared possible positions determined for the row 702A and for the row 702B.

Furthermore, it is possible to provide embodiments comprising two rows of pairs of sensors, or more, for example oriented in different directions, making it possible to identify the target precisely, in particular in the presence of obstacles.

Furthermore, embodiments comprising several generators for a single row of sensors can be used. As an example, a device of the type of that of FIGS. 2A and 2B can comprise two generators arranged on either side of the row, for example on the axis 204, or near ends of the row of pairs of sensors, for example on the axis 203.

Although a mesh has been described in section 2.1 (FIGS. 4A and 4B), any other mesh of the observed region is possible.

Although ultrasonic pulses of increasing frequency have been described, it is possible to use pulses of decreasing frequency, or any other type of pulse suitable for the implementation of matched filtering.

Different methods for locating a potential target have been described here as an example. It will be noted that these methods can be used to locate several targets. Furthermore, the described methods can be adapted to include any method for detecting the presence of one or several targets from the signals received by the sensors.

1. A device for locating a target, comprising:
a generator of ultrasonic waves that can be reflected by the target;
pairs of first and second sensors repeated in a first direction, the first and second sensors of each pair being arranged in a second direction different from the first direction; and
a processing unit suitable for:
a) for each pair of sensors, measuring the phase shift between the ultrasonic waves received by the first sensor and by the second sensor; and
b) establishing that the target is found on a surface corresponding to the differences (Δ(Δϕk)) between measured phase shifts.

2. The device according to claim 1, wherein step b) comprises:
for each point of a mesh of an observed region, calculating a theoretical phase shift for each pair of sensors;
comparing the differences between theoretical phase shifts to the differences between measured phase shifts; and
establishing that the target is located among the points for which the comparison is the best.

3. The device according to claim 2, wherein the pairs of sensors are repeated at a pitch greater than 4 times the wavelength of the ultrasounds, the first and second sensors of each pair are arranged at a center to center distance greater than 4 times the wavelength of the ultrasounds.

4. The device according to claim 1, wherein step a) comprises a measurement of the amplitude of the ultrasounds received by each pair of sensors, and step b) comprises:
b1) for each point of the mesh, calculating, for each pair of sensors, a complex value whose modulus is representative of the measured amplitude and the argument is representative of the differences between measured phase shifts and theoretical phase shifts;
b2) calculating, for each point of the mesh, a sum of the complex values of the various pairs of sensors; and
b3) selecting the points of the mesh for which the sum has the maximum modulus.

5. The device according to claim 4, wherein:
the ultrasounds are emitted by pulses;
in step a), for each pair of sensors, the measured phase shift and amplitude are measured as a function of time; and
step b) comprises determining the part of said surface for which the times of flight of the pulses toward the various pairs correspond to the reception times of the pulses.

6. The device according to claim 5, wherein step b 1) comprises, for each point of the mesh:
b11) calculating, for each pair of sensors, a theoretical time of flight of the ultrasounds to the pair of sensors; and
b12) for each pair of sensors, selecting the measured phase shift and amplitude of the ultrasounds received at the time corresponding to the theoretical time of flight.

7. The device according to claim 6, wherein step b12) comprises:
calculating correlation values between the ultrasounds received by the various pairs of sensors during time intervals centered on the theoretical times of flight; and
giving said complex values moduli that are representative of the correlation values.

8. The device according to claim 6, wherein each pulse is an ultrasound train with wavelengths decreasing as a function of time or increasing as a function of time, and step a) comprises, for each pair of sensors:
a1) receiving and sampling first and second ultrasonic signals by the first and second sensors;
a2) obtaining, by Hilbert transform of each of the first and second ultrasonic signals, first and second complex signals whereof each sample, corresponds to a reception time;
a3) filtering, by matched filtering, each of the first and second complex signals;
a4) associating, with each sample of the first filtered complex signal, the sample of the second filtered complex signal having the best correlation, which results, for each reception time, in a pair, of first and second samples of the first and second filtered complex signals; and
a5) for each reception time-04, determining the measured phase shift by subtracting the arguments of the samples of the corresponding pair of samples from each other, and the amplitude measured from the moduli of the samples of the corresponding pair of samples.

9. The device according to claim 8, wherein the processing unit is suitable, after step a4), for one of the pairs of sensors, for:
defining a reference line parallel to the axis passing through the first and second sensors;
for each reception time, obtaining a phase shift value, representative of the difference between, on the one hand, the measured phase shift and, on the other hand, the theoretical phase shift for the point of the reference line corresponding to the reception time; and
determining the distance between the axis of the centers and the target from the phase shift value.

10. The device according to claim 8, wherein step a5) comprises, for each pair of sensors and each reception time:
a6) selecting the pairs of samples located in a time interval around the considered reception time;
a7) obtaining the phase shift by determining an average difference between the arguments of the first and second samples of the pairs selected in step a6); and
a8) measuring the amplitude of the ultrasounds by determining an average modulus of the samples of the pairs selected in step a6).

11. The device according to claim 1, wherein the sensors are suitable for not significantly detecting the ultrasounds coming from directions forming an angle greater than 80° with the second direction.
